(19) United States
(12) Patent Application Publication
(10) Pub. No.: US 2007/0174644 A1
(43) Pub. Date: Jul. 26, 2007

(54) Apparatus and Method for Dynamic Tokenization of Wireless Network Datagrams

(75) Inventor: Randy C. Willig, Fort Collins, CO (US)

Correspondence Address: HUFFMAN LAW GROUP, P.C., 1900 MESA AVE., COLORADO SPRINGS, CO, 80906, US

(73) Assignee: Tendril Networks, Inc., Boulder, CO (US)

(21) Appl. No.: 11/619,784

(22) Filed: Jan. 4, 2007

Related U.S. Application Data
(60) Provisional application No. 60/756,486, filed on Jan. 4, 2006.

(51) Int. Cl. G06F 1/32

(52) U.S. Cl. 713/320

(57) ABSTRACT

Apparatus and methods are provided for managing the power or bandwidth consumed by a network of interconnected devices. The apparatus includes a service broker and a token processor disposed within one or more of the devices. The service broker monitors traffic over the network, and directs the one or more of the devices in the network to operate in a tokenized data mode. The token processor receives first tokenized data from the service broker and decodes the first tokenized data into first meaningful data. The token processor also encodes second meaningful data into second tokenized data for transmission to the service broker.

### CROSS-REFERENCE TO RELATED APPLICATIONS

This application claims the benefit of the following U.S. Provisional Applications, each of which is herein incorporated by reference for all intents and purposes.

| SERIAL | FILING | |
|---|---|---|
| NUMBER | DATE | TITLE |
| 60/756486 | Jan. 04, 2006 | APPARATUS AND METHOD FOR |
| (TN.0103) | | DYNAMIC TOKENIZATION OF |
| | | WIRELESS NETWORK |
| | | DATAGRAMS |

This application is related to the following co-pending U.S. Patent Applications, each of which has a common assignee and common inventors.

| SERIAL | FILING | |
|---|---|---|
| NUMBER | DATE | TITLE |
| 11/364585 | Feb. 28, 2006 | APPARATUS AND METHOD FOR |
| (TDNW.0101) | | DYNAMIC TOKENIZATION OF |
| | | WIRELESS NETWORK |
| | | DATAGRAMS |

### BACKGROUND OF THE INVENTION

1. Field of the Invention

This invention relates in general to the field of transducer networks, and more particularly to apparatus and methods for managing power across a network of interconnected devices.

2. Description of the Related Art

Networks consisting of hundreds of interconnected transducer devices are now being employed in many areas of the application. These networks, also referred to in the art as “sensor networks,” are used in factory, industrial, and other settings to monitor parameters such as stress, vibration, pressures, temperature, humidity, turbidity, wind speed and direction, tank levels, chemical compositions, electromagnetic levels, frequency, movement, etc. For example, a sensor network may be deployed to monitor the structural integrity of pipelines and structures in, say, a drilling rig, or a bridge, or a skyscraper. In addition, sensor networks are now being employed to monitor and secure inventory in, say, a department store setting.

Sensor networks can include devices that are interconnected via wires, devices that utilize a wireless connection medium, or a combination of wired and wireless devices. Wired network types vary from proprietary interconnection schemes to the ubiquitous TCP/IP-over-Ethernet means of communication. Wireless networks, on the other hand, are now just being introduced into the field. At present, a wireless network typically consists of some number of very low-power, low-data rate transducers, generally interconnected in a mesh configuration. The transducers themselves usually are sensing or control devices coupled to a microcontroller and a low-power radio transceiver via embedded firmware in the microcontroller. Such a transducer configuration is generally referred to as a “device” or “node.” And the interconnection medium between these devices is about the only attribute that they have in common.

Even though a given device may perform the same function (e.g., temperature sensing) as another device on a network, its manufacture may be completely different. The two devices are perhaps programmed differently, it they have different sources of power (e.g., solar power versus AC power), and they may furthermore differ in their capability to perform additional processing over that required to perform their primary functions.

Consequently, creating applications for large, diverse sensor networks is difficult at best due to the sheer volume of differing heterogeneous devices, and the varying longevity and dynamics of the devices. When the numbers and diversity of nodes in a sensor network increases, the complexity of the entire system increases exponentially. One skilled in the art will appreciate that while networking standards such as ZIGBEE™ and IEEE Standard 802.15.4 address the need for an industry-driven open standard, they don't define the tools required to build these systems, nor do these standards provide solutions that allow for system level visibility and control.

As a result, developers of large sensor networks face investing dozens of man-years into developing common “foundational” software services that are unrelated to the application they seek to build. They are forced to develop application code to provide services that, among other requirements of the network, accesses groups of sensor nodes and manages data corresponding to the groups.

The present inventor has noted limitations and problems associated with current device networking technologies that preclude optimum performance. More specifically, the present inventor has observed that the present art lacks any techniques that allow for reducing optimizing the power consumption of networked devices short of simply turning devices off or putting them into a “low-power” mode. Present day techniques for power management actually decrease the performance of a system composed of a network of interconnected devices because those devices that are turned off cannot function. Similarly, devices that are placed in a low-power mode typically usually step down performance as well.

Many devices have an inherent limitation on the amount of power they can consume in order to accomplish a function. Beyond the power necessary to provide a function on a device, it is also frequently necessary to transmit information across a network. The act of transmitting the information consumes power as well, complicating the power consumption needs of the device. In both wired and wireless sensor devices, transmitter circuits use, on average, many times the amount of power that is required to perform their basic sensing or actuating function.

It is additionally noted that wired and/or wireless communications over a network utilizes valuable network bandwidth (e.g., time and/or frequency slots). Such may not be a concern in a network having a small number of devices or one in which bandwidth is not a concern. But in a network comprising hundreds of interconnected, low-data-rate devices, or in deployment scenarios where transmission security is an issue, bandwidth management may be desirable as well.

Most present day research on network level power and bandwidth management focuses on transport efficiency, synchronized transmission/reception times, and optimized routing protocols. Furthermore, since the research and techniques available do not consider the varied power/bandwidth models of sensor devices across a network, they certainly provide nothing that would allow for overall network power/bandwidth management without degraded performance.

Consequently, the present inventor has observed that if the devices in a network are capable of sharing information about their instantaneous power and/or bandwidth profile, and in particular the amount of power and/or bandwidth that is required to communicate sensor data over the network, it is highly advantageous to utilize this information to dynamically tokenize communications to/from sensor nodes in order to reduce the power and network bandwidth consumed by the sensors without affecting performance or functionality of the sensor network itself. In addition, the present inventor has noted that even if no information regarding power or bandwidth is shared by devices in a network, it is still advantageous for reasons stated to employ dynamic tokenization for communications to/from the sensor nodes.

### SUMMARY OF THE INVENTION

The present invention, among other applications, is directed to solving the above-noted problems and addresses other problems, disadvantages, and limitations of the prior art. The present invention provides superior techniques for managing the power profile or bandwidth profile of a network of interconnected devices. In one embodiment, an apparatus is provided for managing a network of devices. The apparatus includes a service broker and a token processor. The service broker is configured to monitor traffic over the network, and is configured to direct one or more of the devices in the network to operate in a tokenized data mode. The token processor is disposed within the one or more of the devices in the network. The token processor is configured to receive first tokenized data from the service booker and to decode the first tokenized data into first meaningful data. The token processor is also configured to encode second meaningful data into second tokenized data for transmission to the service broker.

One embodiment of the present invention contemplates a network of interconnected wireless devices. Another embodiment considers a combined wired/wireless network of devices.

One aspect of the present invention contemplates a management mechanism for controlling the power or bandwidth consumed by devices within a network. The management mechanism has a service broker and a token processor. The service broker monitors traffic over the network, and directs one or more of the devices to operate in a tokenized data mode. The service broker includes dynamic tokenization logic that is configured to provide a tokenized definition, if required, to be transmitted along with a tokenized mode command to the one or more of the devices. The token processor is disposed within the one or more of the devices in the network. The token processor is configured to receive first tokenized data from the service broker and to decode the first tokenized data into first meaningful data. The token processor is further configured to encode second meaningful data into second tokenized data for transmission to the service broker.

Yet another aspect of the present invention comprehends a method for optimizing power or bandwidth consumed by a network of devices. The method includes monitoring traffic over the network; direction one of more of the devices in the network to operate in a tokenized data mode; and within the one or more devices in the network, receiving first tokenized data and decoding the first tokenized data into first meaningful data, and encoding second meaningful data into second tokenized data for transmission.

### BRIEF DESCRIPTION OF THE DRAWINGS

These and other objects, features, and advantages of the present invention will become better understood with regard to the following description, and accompanying drawings where:

FIG. 1 is a block diagram illustrating an exemplary present day network of heterogeneous devices;

FIG. 2 is a block diagram depicting a network-aware management configuration according to the present invention;

FIG. 3 is a block diagram featuring an exemplary transport datagram payload according to the configuration of FIG. 2;

FIG. 4 is a block diagram showing an exemplary tokenized payload according to the present invention;

FIG. 5 is a block diagram illustrating an alternative exemplary tokenized payload according to the present invention;

FIG. 6 is a flow chart detailing a method according to the present invention for managing network power via dynamic tokenization; and

FIG. 7 is a flow chart illustrating a method according to the present invention for managing network bandwidth via dynamic tokenization.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

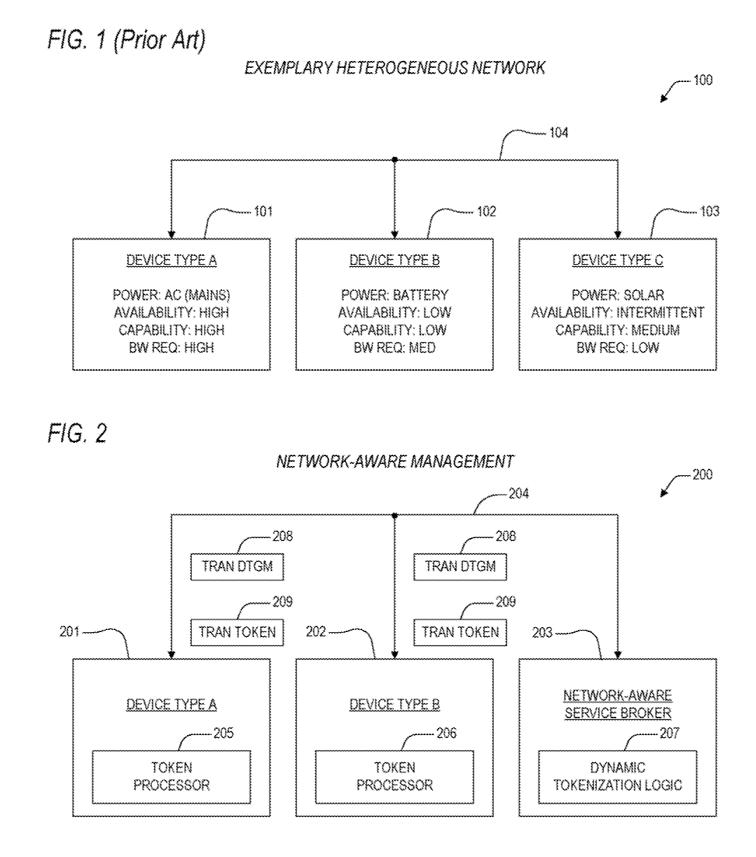

In view of the above background discussion on transducer networks and present day techniques which are employed therein to perform power/bandwidth management functions, a discussion of the limitations of such techniques will now be presented with reference to FIG. 1. Following this, a discussion of the present invention will presented with reference to FIGS. 2-7. In contrast to present day power and bandwidth management techniques, the present invention enables transducers within a network to express power and bandwidth availability and functional requirements within the network as a set of network available meta-properties, so that the networked system is enabled via tokenization mechanisms according to the present invention to intelligently allocate and control the power and/or bandwidth consumed by the system and individual devices within the system, without affecting performance.

Referring to FIG. 1, a block diagram is presented illustrating an exemplary present day network 100 of heterogeneous devices 101-103. For purposes of illustration, the devices 101-103 are coupled together via a networking medium 104, but each of the devices 101-103 are different in some aspect. For instance, all three devices 101-103 may be sensor devices 101-103, but they are produced by different manufacturer's and as a result, have different requirements for setup, programming, and etc. Alternatively, the devices 101-103 could be produced by the same manufacturer and have similar programming requirements, but they form part of a heterogeneous network 100 because they are different types of transducers. In a broad sense consistent with the scope of this application, a heterogeneous network 100 comprises one or more devices 101-103 coupled together via one or more different network mediums 104, which are required to function together for purposes of achieving an overall system function. Hereinafter, the term “sensor” 101-103 may be employed to refer to a transducer device 101-103, but the functional scope of the device should not be restricted to a sensing function. Rather, a sensor 101-103 in sense used herein may be employed as an output of the network 100 (e.g., an audio speaker, a radiating element, an emitting device, a control valve, a flashing light) as well.

Heterogeneous networks 100 consisting of hundreds, or even thousands of transducers 101-103 are being fielded in increasing numbers. To illustrate, consider an application where a sensor network 100 is employed within a large cargo ship to detect all sorts of environmental data (e.g., a sensing function) and to control various equipment (e.g., a controlling function). The network 100 comprises hundreds of highly contstrained sensor and control nodes 101-103. In this application, exemplary sensors 101-103 include vibration and stress-sensing sensors 101-103 attached to the hull of the ship to monitor structural parameters; temperature sensors 101-103 on equipment in the ship's engine room; temperature and humidity sensors 101-103 connected throughout the ship to check overall conditions for both personnel and equipment; and accelerometers 101-103 attached to the hull to detect normal and extreme movements. In addition, transducers 101-103 such as fan controls 101-103 are provided to monitor the ship's ventilation system; motor and valve controls 101-103 are attached to engine room equipment and equipment in other machine rooms; fuel and energy supply valve controls 101-103 are employed restrict fuel flow in case of dangerous conditions; and radio frequency identification (RFID) and other tracking sensors 101-103 are provided on each cargo container to monitor movement, internal/external temperature, and to detect tampering.

The above example illustrates the extremely diverse nature of a present day heterogeneous sensor network 100, a portion of which is illustrated in the block diagram of FIG. 1. Now, to focus attention on the limitations of a conventional heterogeneous network 100, consider a meteorological application, where device A 101 is embodied as an anemometer, device B 102 as a rain gauge, and device C 103 as a temperature sensor. The devices 101-103 may be provided power from one or more types of power sources including, but not limited to, AC (mains), AC (generator), battery, and solar source. Device A 101 is powered by AC (mains), and is thus highly available for use. In addition, device A 101 is highly capable of performing its function (e.g., sensing wind speed), plus perhaps other functions as well (e.g., sensing wind direction, or temperature, or humidity). In addition, a relatively high amount of bandwidth over the network medium 104 required by Device A 101 to provide for communication of its data.

Device B 102 is shown to be powered by battery and thus exhibits a low availability to the network 100. In addition, device B 102 has low capabilities to perform other functions and requires an average amount of bandwidth over the network medium 104 to provide for communications of its data. Device C 103 is solar powered and thus exhibits an intermittent availability to function. Also, device C 103 has a medium capability to perform other functions besides that allocated and requires a relatively low amount of bandwidth over the network medium 104 to provide for communication of its data.

As alluded to above, the devices 101-103 are interconnected through a network medium 104. Examples of networking mediums 104 include, but should not be restricted to, local area networking media 104 such as Ethernet, short distance networking media 104 such as BLUETOOTH®, Wi-Fi, IEEE 802.11 wireless network media 104, and small sensor network media 104 such as ZIGBEE™ and proprietary network media 104 performing substantially similar function. Each of the devices 101-103 in this example are configured to manage power and/or bandwidth in an isolated fashion, that is, in complete isolation to the issues and concerns of other devices 101-103 in the network 100 or of the network medium 104, or of transport mechanisms across the network medium 104. Since each of the devices 101-103 does not maintain any understanding of the power/bandwidth capabilities or restrictions of the other devices 101-103 in the network 100, there is no system-wide usage coordination. Hence, the devices 101-103 provide for a few, simplistic states such as ON, SLEEP, and SUSPEND. State control may be more granular at the level of a device 101-103, such as that exhibited by present day laptop computers, but it is noted that a present day heterogeneous network 100 is limited in the sense that no single device 101-103 is aware of, or is capable of controlling the power or bandwidth consumed by another device 101-103 on the network 100. In addition, bandwidth is typically managed from the standpoint of reduction in transmissions (e.g., SLEEP) or loss of data integrity (e.g., reducing number of data bits transmitted).

The present inventor has observed that the inability to effectively and efficiently sense and control the power and bandwidth consumed by the devices 101-103 comprising a heterogeneous network 100, from a network-wide perspective, significantly limits the overall performance of the corresponding system 100. It has been further noted that it is desirable to manage the power and bandwidth consumed by the devices from a system-level perspective without reducing the performance of individual devices, thus increasing the overall performance of the networked system 100 while providing advantages in the areas of system availability and electromagnetic signature reduction.

As observed above, there have been attempts in the art to work around the limitations of heterogeneous networks 100. For example, in U.S. Pat. No. 6,028,857, Poor discloses a self-organizing wireless network. The network consists of a plurality of nodes (e.g., devices 101-103), each of which is configured to originate messages, to be a destination of messages, and to relay messages. The messages are transmitted in a frame that includes the cost of conveying the message to a destination node. Also included in the frame is the cost so far expended in conveying the message. Consequently, each time a message frame is transmitted, either by an originating node or by a relaying node, the node ascertains whether the cost to convey the message from that node to the destination node is less than the conveying cost contained in the received frame. If it is, then the node retransmits the frame after having incremented the incurred cost by the relay cost of that node and decremented the cost to convey by the same value. Otherwise the node discards the message.

Poor's network indeed provides for limiting the amount of power consumed and bandwidth which is associated to transmission of a single message. Such a mechanism is useful to control the cost of network communications over a wireless network, but, as noted above, the result is degraded performance of the networked system due to dropped transmissions. Poor moreover does not address any form of communications that enable one or more nodes 101-103 to become aware of the limitations of other nodes 101-103 from a power consumption, bandwidth, availability, or capability perspective, nor does he provide any sort of motivation that would lead one skilled in the art to implement any sort of technique which would maintain or improve overall system performance by managing the power/bandwidth consumed, or functions performed, by one or more devices 101-103 on the network.

In addition, the present inventor, in U.S. Pat. No. 6,684,339, teaches a technique for transferring information from a first device 101-103 to a second device 101-103 when the first device 101-103 goes under a reduced power mode. Accordingly, the technique is employed in a system comprising a plurality of devices 101-103 that are connected together in a network 100. The patent discloses a system and method of transferring information from the first device 101-103 in the network 100 to the second device 101-103 when the first device is operating in the reduced power mode. The first device 101-103 acts as a second power supply for supplying power to the first device 101-103 when a first power supply fails. The first device 101-103 also has a controller for transferring information from the first device to a second device 101-103 over the network 104 when the first device 101-103 is receiving power from the second power supply. The second device 101-103 receives the information that has been transferred from the first device 101-103 over the network 104.

Although information is transferred from one device 101-103 to the next, the invention of U.S. Pat. No. 6,684,339 does not address, or even allude to, proactive management of the power or bandwidth of a networked system 100 based upon a top-level consideration of power consumption. Rather, the invention provides for a reactive, fallback mode of operation, whereby a given sensor 101-103 offloads its collected data to another sensor 101-103 when the given sensor experiences a failure of its primary power supply. The offload of data is accomplished using a secondary, or backup, power supply. In addition, the functions of one device 101-103 are completely lost, thereby resulting in decreased functionality of the networked system.

The two above-noted disclosures, along with other teachings in the related art, are lacking the ability to enable a network 100 of perhaps thousands of heterogeneous devices 101-103 to exhibit increased or enhance performance (e.g., availability of system function) because the power and bandwidth consumed and/or functions performed by particular devices 101-103 are noted and controlled over the network medium 104. The present inventor has noted that prior art methods of system design cannot affect power/bandwidth management at a system level or at a device level without impact on performance. Power management, in addition, is only enabled at the device level, and in addition the power can only be managed in a few, discrete number of power states. It is furthermore noted again that most present day commercial and academic research on network level power management focuses on transport efficiency, synchronized transmission/reception times, and optimized routing protocols, as is exemplified by the teachings of U.S. Pat. No. 6,028,857, discussed above. These conventional design techniques do not consider the varied power, capability, and bandwidth models of devices 101-103 across the network 100, and there is moreover no mechanism in place for devices 101-103 to cooperate in order to achieve effective system-wide power/bandwidth/performance management.

The present invention overcomes the above noted problems in the art, and others, but providing a complete, dynamic, system-wide power/bandwidth management solution. As noted above, present day power management techniques are based on discrete devices having a limited number of discrete power “states” and bandwidth management is accomplished by reduction in data integrity via reduced transmissions, static protocol header compression techniques, or decreasing the number of total data bits transmitted over the network. In addition, in many low-power/low data rate (LP/LDR) networks, the configuration of devices 101-103 on the network is dynamic, so that the overall power and bandwidth profiles of the network 100 may undergo significant changes due to changes in number and type of devices 101-103, ambient node conditions (e.g., weather, time of day), and other ephermal constraints (e.g., electromagnetic environment). Thus, the present inventor has noted the need to determine and manage the operating profile of present day LP/LDR networks to an extent that has not been heretofore provided for.

As will be described in further detail below with references to FIGS. 2-7, the present invention enables devices within a heterogeneous network to express power/bandwidth availability and functional requirements within the network as a set of network available meta-properties. Techniques are provided to define the requirements of participation in the network and to additionally define the requirements of associated transport mechanisms. These defined properties are evaluated at the device and network level by a network-aware service broker, so that power and bandwidth is managed at both the device and system level without disregarding the overall performance of the network. Devices according to the present invention support a cooperative system-wide power/bandwidth management strategy though the ability to dynamically tokenize mission critical datagram parameters to enable reduction in bandwidth when required (along with corresponding power required for transmit/receive functions) and to schedule power use coincident with power availability and system mission. Advantageously, the networked system is enabled to intelligently allocate and control the power and bandwidth consumed by the system.

Turning now to FIG. 2, a block diagram is presented showing a network-aware management configuration 200 according to the present invention. The configuration 200 includes a plurality of LP/LDR devices 201-202 that are coupled to a network aware service broker 203. Each device 201-202 includes a respective token processor 205-206. Like those devices 101-103 discussed with reference to FIG. 1, devices 201-202 according to the present invention may be embodied as any type of LP/LDR device 201-202 that is currently networked or that may be contemplated for networking in the future over any network medium 204 including LP/LDR devices 201-202 such as switches, transducers, sensors, routers, controllers, monitors, and the like. For example, the devices 201-202 may be sensing devices 201-202 (e.g., temperature, light, power, pressure, x-ray, and etc.), control devices 201-202 (e.g., desktop computer, laptop computer, industrial controller, mainframe computer, microcontroller, ASIC, router, gateway, etc.), or they may be software/firmware components 201-202 (e.g., application programs, operating systems, shells) existing within other devices. Furthermore, the devices 201-202 according to the present invention may be provided power from one or more types of power sources including, but not limited to, AC (mains), AC (generator), battery, and solar source. In contrast to present day devices 101-103, the devices 201-202 according to the present invention allow for network-aware power/bandwidth management through the employment of one or more tokenized datagrams 208 when such use is directed on an individual device basis by the service broker 203. In one embodiment, the service broker 203 comprises a transport-level driver within a layered communications protocol that provides for direct application program access. In one embodiment, the service broker 203 comprises a transport-level driver within a layered communications protocol that provides for direct application program access. In one embodiment, the service broker 203 is disposed as a JAVA™ application executing on a JAVA virtual machine (JVM) that is coupled to the network medium 204 for purposes of providing reliable transport of data over the LP/LDR network 200 and an application programming interface (API) to upper layer applications. In one embodiment, the devices 201-202 and service broker 203 communicate over an IEEE 802.15.4 wireless network 204 employing ZIGBEE or a similar protocol as a network layer protocol directly under the transport layer. Alternative network media 204 are contemplated as well to include cellular media, Wi-Fi, wired internet, and a combination of media types.

In contrast to present day devices 101-103, the devices 201-202 according to the present invention provide for network-aware power, bandwidth, and performance management through the employment of power descriptor data that is communicated to the service broker 203 according the particular communications protocol commensurate with the network medium 204. The descriptor data allows for determination of current power and supports options for power reduction that include the tokenization of data that is transferred between the devices 201-202 and the broker 203. In one embodiment, one or more of the devices 201-202 is embodied as a transducer disposed within computing elements capable of communicating over the network medium 204 according to the particular network protocol employed. In another embodiment, the computing elements comprise microcontrollers or microprocessors and associated memory and interface logic. Other discrete and analog embodiments are contemplated as well.

An embodiment of the service broker 203 comprehends a computing device coupled to the network medium 204 providing web services (to include web service distributed management functions) related to performance of the functions required by the system 200. In one embodiment, the web services comport with standard application developer paradigms (e.g., such as are useful to a JAVA™, NET, or C++ developer) and be easily integrated into popular development environments such as Eclipse, INTELLIJ™, or MICROSOFT VISUAL® NET. Alternatively, the web services are embodied as a set of libraries and tools with a run-time engine that is disposed on a computing device. It is noted that web services are also known as “service brokers” and these brokers serve as structured mechanisms to coordinate communications, such as forwarding requests from a node (e.g., device) 201-203 to a corresponding application. program, providing for communications from node 201-203 to node 201-203. In one embodiment, a service broker device 203 is contemplated that provides for communications between ZIGBEE-based wireless nodes 201-203.

In operation, the service broker 203 monitors traffic over the network media 204 to/from each of the devices 201-202 as well as their power type, power state (including power required by transceivers disposed within), local conditions relative to each device 201-202, and local ephermal parameters. In addition, the service broker 203 employs each of these types of data, as well as data obtained from other sources (e.g., National Weather Service warnings) to generate a system-wide power, processing, and bandwidth model. In the event that it is required to reduce the emissions and/or transmit power associated with one or more of the LP/LDR nodes 201-202, dynamic tokenization logic 207 within the service broker 203 is employed to direct the one or more of the nodes 201-202 to enter into a tokenized datagram mode. Thereafter, and until directed to exit the tokenized datagram mode by the service broker 203, the one or more of the nodes 201-202 communicates with the service broker 203 by employing transport tokens 209 rather than transport datagrams 208. The tokens 209 or datagrams 208 comprise the payload portion of a transport-level packet, which will be describe in exemplary detail below with reference to FIG. 4. The transport-level packet is analogous to the payload portion of the well-known and understood TCP segment.

When in tokenized datagram mode, the one or more nodes 201-202 employs the token processor 205-206 disposed therein to decode received tokens 209 into meaningful data and to encode data into tokens 209 for transmission over the network 204 to the service broker 203.

In one embodiment, a mapping of specific transport datagrams 208 to corresponding tokens 209 is predefined and programmed into the one or more of the devices 201-202. Consequently, the dynamic tokenization logic 207 enables the service broker 203 to direct the one or more devices 201-202 to enter/exit the tokenized datagram mode. In an alternative embodiment, datagrams 208 are dynamically mapped to corresponding tokens 209 and such is communicated to the one or more devices 201-202 by the tokenization logic 207 prior to entering tokenized datagram mode. The present invention contemplates any number of token generation algorithms to include simple mapping, one-way hash functions, incrementing index functions, leading zero stripping, etc., to dynamically compress data for transmission over the network 204, thereby resulting in less bandwidth usage, and less power consumption per device 201-202 associated with transmit and receive functions. As noted above, and as will be appreciated by one skilled in the art, radio functions in wireless devices 201-202 require many times more power than is otherwise required to operate the devices 201-202.

In one embodiment, the service broker 203 may invoke the tokenized datagram mode according to weather conditions, say, when an individual device 201-202, powered by a solar cell, is under cloud cover or conditions that otherwise constrain local power. In an alternative embodiment, the broker 203 may invoke tokenized datagram mode for all devices 201-202 in the network do inhibit electromagnetic emissions or for reasons to inhibit or otherwise thwart electronic surveillance. The present inventors note, however, that tokens 209 according to the present invention uniquely map to particular transport datagrams 208 and do not result in degraded performance of the system mission. In a one-to-one embodiment, a single token 209 is mapped to a corresponding transport datagram 208. In a one-to-many embodiment, a single token 209 is employed to represent a plurality of datagrams 208. Accordingly, a single packet comprising a one-to-many token 209 may be employed in place of a plurality of packets.

In an exemplary embodiment, a particular device token 209 may indicate “no change” from a previous transmission, while a second device token 209 may indicate “data has changed”. In such a case, when the second token 209 is received by the service broker 203, the tokenization logic 207 therein will direct that the particular device 201-202 exit from tokenized datagram mode so that the changed data can be transmitted.

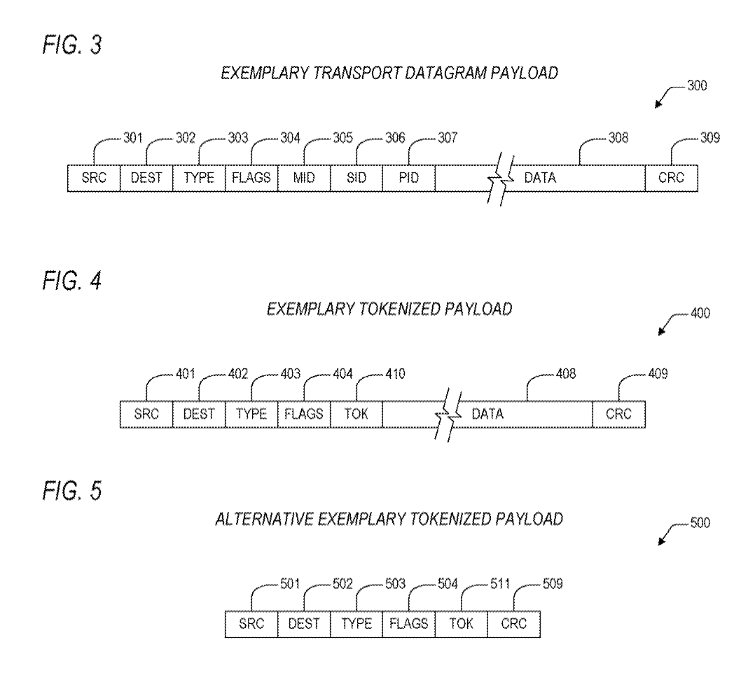

Now referring to FIG. 3, a block diagram is present featuring an exemplary transport datagram payload 300 according to the present invention. The payload 300 has a source port field 301, a destination port field 302, a transport type field 303, a flags field 304, a message identification field 305, and service identification field 306, property identification field 307, a data field 308, and a cyclic redundancy checksum (CRC) field 309. The source field 301 identifies a transport-level port on a sending device from which the payload 300 originates. The destination field 302 identifies a transport-level port on the receiving device for which the payload 300 is intended. The type field 303 identifies the type of transport employed (e.g., reliable datagram, best effort, etc.). The flags field 304 describes useful information that distinguishes one payload 300 from another payload 300 to include, but not limited to, sequence numbers, acknowledge indications, initial transmission indication, and retransmit indication. The message ID field 305 identifies the type of tranport payload 300 such as read request, read response, discovery, etc. The service ID field 306 identifies the type of service provided by the device 201-202 or broker 203 to which the payload 300 applies. Exemplary services include temperature services, humidity services, wind sensing services, fluid turbidity services, valve actuation services, etc. The property ID field 307 designates the specific property (e.g., temperature, humidity, wind speed, wind direction, fluid level, turbidity) corresponding to data that is contained in the data field 308. The CRC field 309 is a CRC of the payload 300. In one embodiment, the CRC field 309 is an 8-bit CRC.

Turning now on FIG. 4, a block diagram is presented featuring an exemplary tokenized datagram payload 400 according to the present invention. The payload 400 has a source address field 401, a destination address field 402, a transport type field 403, a flags field 404, a token field 410, a data field 308, and a cyclic redundancy checksum (CRC) field 409. The fields 401-404, 408, 409 of the tokenized payload 400 operate in substantially the same manner as like-numbered fields 301-304, 308, 309 of the exemplary payload 300 of FIG. 3, where the hundreds digit is replaced by a “4”. In addition, the token field 410 represents a unique mapping of selected values of the combined MID, SID, and PID fields 305-307 of the exemplary payload 300. In one embodiment, the MID, SID, and PID fields 305-307 are each 8-bit fields 305-307 which are compressed into a single 8-bit token field 410. The exemplary tokenized payload 400 is employed by a device 201-202 according to the present invention when the device 201-202 is operating in token mode as directed by the broker 203. Accordingly, the token processor 205-206 within the device 201-202 is employed to decode the token field 410 to obtain one of the selected values of the combined MID, SID, and PID fields 305-307 when the payload 400 is received from the broker 203. In addition, the token processor 205-206 is employed to encode the selected values as required to transmit the tokenized payload 400 to the broker 203.

Referring to FIG. 5, a block diagram is presented featuring an alternative exemplary tokenized datagram payload 500 according to the present invention. The payload 500 has a source port field 501, a destination port field 502, a transport type field 503, a flags field 504, a token field 511, and a cyclic redundancy checksum (CRC) field 509. The fields 501-504, 509 of the tokenized payload 500 operate in substantially the same manner as like-numbered fields 301-304, 309 of the exemplary payload 300 of FIG. 3, where the hundreds digit is replaced by a “5”. More particularly, those fields labeled 5XX having “XX” digits that match those fields labeled 3XX in FIG. 3 operate in substantially the same manner as has been herein described. In addition, the token field 511 represents a unique mapping of selected values of the combined MID, SID, PID, and data fields 305-308 of the exemplary payload 300. In one embodiment, the MID, SID, and PID fields 305-307 are each 8-bit fields 305-307 and the data field 308 is between 1 and 80 octets in size—all of which are compressed according to the present invention into a single 8-bit token field 511. The alternative exemplary tokenized payload 500 is employed by a device 201-202 according to the present invention when the device 201-202 is operating in token mode as directed by the broker 203. Accordingly, the token processor 205-206 within the device 201-202 is employed to decode the token field 410 to obtain one of the selected values of the combined MID, SID, PID, and data fields 305-308 when the payload 500 is received from the broker 203. In addition, the token processor 205-206 is employed to encode the selected values as required to transmit the tokenized payload 400 to the broker 203.

Although exemplary tokenized payloads 400, 500 have been described herein the present inventors note that such examples are provided to clearly teach essential attributes of the present invention, but not in addition that such examples should not be employed to restrict the scope of that invention which is comprehended. The present invention contemplates many such tokenization schemes whereby a broker device 203 dynamically directs individual LP/LDR devices 201-202 over a network 204 to enter/exit tokenized datagram mode in order to manage either device-level characteristics or to provide management of system level attributes. For example, one skilled in the art will appreciate that more local processing resources are required to encode/decode tokens 209 at the device level that are otherwise required during normal operation. And the present invention comprehends that local processing resources within a given device 201-202 may be managed by a service broker 203 according to the present invention to, say, free up local processing resources by directing the given device 201-202 to exit tokenized datagram mode.

It is also noted that the transport payloads 300, 400, 500 described herein may indeed span more than one packet which is transmitted over the network 204. In one embodiment, 128-byte packets are transmitted over a network 204 that comports with IEEE 802.15.4 protocol.

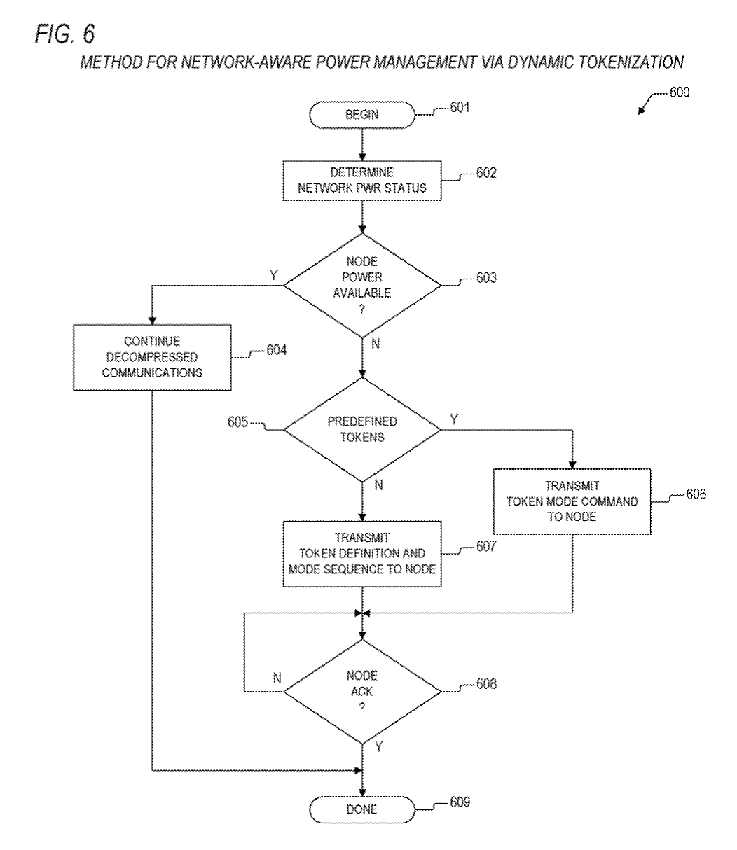

Now turning to FIG. 6, a flow chart is presented illustrating a method 600 according to the present invention for managing the power consumed by a device on a LP/LDR network.

Flow begins at block 601 where a service broker according to the present invention begins a power evaluation of devices connected to the network. Flow then proceeds to block 602.

At block 602, an evaluation of the power status of the network of devices. Flow then proceeds to decision block 603.

At decision block 603 an evaluation is made to determine if there is sufficient power available to a given device for performance of the functions required. If so, then flow proceeds to block 604. If not, flow then proceeds to decision block 605.

At block 604, since sufficient power is available to the device, a service broker according to the present invention determines to continue decompressed communications (i.e., normal datagrams). Flow then proceeds to block 609.

At decision block 605, an evaluation is made to determine whether tokens have been predefined or whether dynamic mapping of datagrams to tokens is required. If tokens have been predefined, then flow proceeds to block 606. If dynamic definition is required, then flow proceeds to block 607.

At block 606, dynamic tokenization logic within the broker transmits a tokenized mode command (or sequence of commands) over the network to direct the selected node to enter tokenized mode. Flow then proceeds to decision block 608.

At block 607, dynamic tokenization logic within the broker transmits a tokenized definition and mode command (or sequence of commands) over the network to direct the selected node to define tokens for subsequent communications and to enter tokenized mode. Flow then proceeds to decision block 608.

At decision block 608, an evaluation is made to determine if the node has acknowledged commands provided by the service broker. If not, then flow loops back to decision block 608. If so, then the broker begins communications with the selected node(s) using tokens instead of normal payloads. Flow then proceeds to block 609.

At block 609, the method completes.

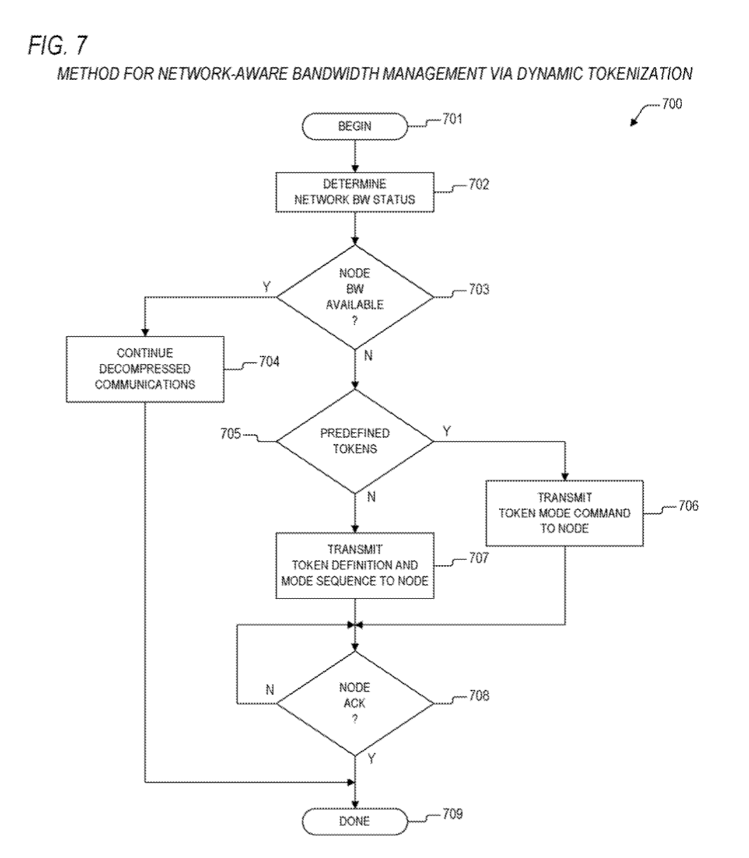

Now referring to FIG. 7, a flow chart is presented illustrating a method 700 according to the present invention for managing the bandwidth consumed by a device on a LP/LDR network.

Flow begins at block 701 where a service broker according to the present invention begins a bandwidth evaluation of devices connected to the network. Flow then proceeds to block 702.

At block 702, the bandwidth status of the network is determined. Flow then proceeds to decision block 703.

At decision block 703, an evaluation where it is determined if there is sufficient bandwidth available to a given device for performance of the functions required. If so, then flow proceeds to block 704. If not, flow then proceeds to decision block 705.

At block 704, since sufficient bandwidth is available to the device, the broker decides to continue decompressed communications (i.e., normal datagrams). Flow then proceeds to block 709.

At decision block 705, an evaluation is made to determine whether tokens have been predefined or whether dynamic mapping of datagrams to tokens is required. If tokens have been predefined, then flow proceeds to block 706. If dynamic definition is required, then flow proceeds to block 707.

At block 706, dynamic tokenization logic within the broker transmits a tokenized mode command (or sequence of commands) over the network to direct the selected node to enter tokenized mode. Flow then proceeds to decision block 708.

At block 707, dynamic tokenization logic within the broker transmits a tokenized definition and mode command (or sequence of commands) over the network to direct the selected node to define tokens for subsequent communications and to enter tokenized mode. Flow then proceeds to decision block 708.

At decision block 708, an evaluation is made to determine if the node has acknowledged commands provided by the service broker. If not, then flow loops back to decision block 708. If so, then the broker begins communication with the selected node(s) using tokens instead of normal payloads. Flow then proceeds to block 709.

At block 709, the method completes.

Although not specifically detailed in the flow diagrams of FIGS. 6-7, substantially similar methods (not shown) are contemplated for management of processing resources, or for any combination of power, bandwidth, and processing resources as well.

As a natural extension of the invention disclosed herein, it is conceivable that devices will progress to a richer and more robust set of descriptors that detail not only power and bandwidth characteristics, but also many other valuable characteristics of the devices and the network itself. The present inventors therefore note that any extension of the original idea to optimize the characteristics of devices in a network is not limited to and is not constrained by examples from the power, bandwidth, and processing management areas provided herein. For example, one skilled in the art will appreciate that the present invention is applicable to optimizing other characteristics, attributes, or parameters of a network from the network-wide perspective to include, but not to be limited to, thermal characteristics and cost.

The present invention can be employed in any system configuration that contemplates a network of power-constrained or bandwidth-constrained devices, as well as in any other configuration where it is desirable to manage overall power consumption or bandwidth. The present invention is network medium and device agnostic, and has the advantage of reducing power consumption and bandwidth utilization from both a device level and system level perspective. Another advantage of the present invention is that a reduction in bandwidth of a system placed into token mode results in an overall reduction in electronic emissions, which may be desirable for certain deployment scenarios. Tokenization modes according to the present invention also provide countermeasures against network hacks due to the dynamic reconfiguration of packetized data.

Although the present invention and its objects, features, and advantages have been described in detail, other embodiments are contemplated by the present invention as well. For example, the present invention has been characterized in part in terms of a network of low-power/low data rate wireless sensors and transducers. Such networks certainly can benefit from the features afforded by the present invention. But the scope of the present invention should not be constrained to wireless network applications. Rather, it is noted that the present invention comprehends networks that are hard-wired as well, such as, but not limited to, industrial automation networks, building maintenance (e.g., automated lighting, HVAC, etc.), and networks of interconnected computers and computing devices. Likewise, the present invention contemplates a combination of network topologies such as a network of wireless transducers deployed remotely that are accessed via a wireless node having connection to the Internet via any number of connection means (e.g., an internet gateway), where control of the power consumption and bandwidth of the wireless devices is affected by one or more service broker devices that are coupled to the Internet and operating at a location removed from the location where the sensor network is deployed.

In addition, although the present invention has been chiefly described in terms of a service broker that is coupled to a network of devices, it is not required that a separately coupled service broker be provided. Rather, a service broker according to the present invention could also be embodied within one or more devices that are disposed in a peer-to-peer network of devices, regardless of whether or not a separate service broker is present. In this embodiment, the one or more nodes would collectively perform those functions that have herein been described specifically as being handled by a separately coupled service broker, particularly those functions associated with processing, encoding, and decoding of tokenized data.

A further embodiment of the present invention contemplates a dynamic tokenization system where the end node devices themselves, rather than the service broker, evaluate conditions and implement tokenization schemes. According to this embodiment, an end node device would provide one or more additional fields within the tokenized payload 400 of FIG. 4, that travel concurrently with the payload 400 sent to the service broker. The additional fields indicate to the service broker when tokenization mode is being employed, and may further carry a mapping of a particular token to data that is being tokenized. For example, whenever the end node device determines that there is data that may be repeated, it sends one or more of the additional fields that indicate commencement of tokenized data mode, including a token number, and the data to which the token corresponds. The service broker receives this payload 400, and stores the provided information. And for subsequent payloads 400, the end node device simply sends a token in use indicator within one of the additional fields, as well as the token ID. The service broker receives the token ID and performs those functions necessary to substitute the data to which the token corresponds for the token ID. One advantage of this embodiment is that a mechanism is provided that allows for simple decisions to be made by a node according to the present invention which could enable a large set of tokenized datagrams that would be unique to that device. Another feature of this embodiment is that it does not require a setup or negotiation phase with the service broker. And when the information being transmitted by the end node device changes, the node simply sends the changed data along with the additional fields that indicate that tokenized data more for the particular token ID has ended.

Yet another embodiment of the present invention extends the previously described embodiment by providing additional techniques for tokenizing data for transmission. For example, in addition to directly mapping a token to a specific data field and employing one or more of the additional fields to indicate commencement and end of tokenized data mode, different ones of the additional fields within the tokenized payload 400 are employed to indicate variation of the tokenized data. For example, if an end node device has commenced sending tokens to a service broker, where the token IDs have been defined as described above to map to a particular data value, the different ones of the additional fields may be encoded to indicate that a prescribed variation of the data corresponding to the token ID is being transmitted as opposed to the particular data value. Consider for instance that the end node device has commenced tokenized mode for token ID “X” that is mapped to a data value indicating, say “72 degrees.” Two of the different fields may be employed where one field indicates a “token plus variable field” is being transmitted and the second field comprises, say, a twos complement variable field. Upon receipt, the service broker sums the contents of the variable field with the data corresponding to token “X” to yield the variation from 72 degrees. Thus, only the variation from the data need be sent according to this embodiment.

Those skilled in the art should appreciate that they can readily use the disclosed conception and specific embodiments as a basis for designing or modifying other structures for carrying out the same purposes of the present invention, and that various changes, substitutions and alterations can be made herein without departing from the scope of the invention as defined by the appended claims.

What is claimed is:

1. An apparatus for managing a network of devices, the apparatus comprising:
a service broker, configured to monitor traffic over the network, and configured to direct a first one or more of the devices in the network to operate in a tokenized data mode; and
a token processor, disposed within said first one or more of the devices in the network, configured to receive first tokenized data from said service broker and to decode said first tokenized data into first meaningful data, and configured to encode second meaningful data into second tokenized data for transmission to said service broker.

2. The apparatus as recited in claim 1, wherein the network of devices comprises a plurality of wireless devices communicating over a wireless network medium.

3. The apparatus as recited in claim 2, wherein the network is configured according to ZIGBEE standards.

4. The apparatus as recited in claim 1, wherein the network of devices comprises a combination of wired and wireless devices communicating over a wired network medium and a wireless network medium, and wherein said service broker provides for interconnection of the network of devices.

5. The apparatus as recited in claim 1, wherein said device broker transmits a tokenized mode command to said first one or more of the devices to direct operation in said tokenized data mode.

6. The apparatus as recited in claim 5, wherein said service broker comprises:
dynamic tokenization logic, configured to provide a tokenized definition to be transmitted along with said tokenized mode command to said first one or more of the devices.

7. The apparatus as recited in claim 1, wherein said tokenized data comprises compressed data corresponding to a plurality of fields within a transport level packet.

8. The apparatus as recited in claim 7, wherein said plurality of fields comprise a message ID field, a service ID field, and a property ID field.

9. The apparatus as recited in claim 8, wherein said plurality of fields further comprise a data field.

10. The apparatus as recited in claim 1, wherein the network of devices comprise one or more sensing devices.

11. The apparatus as recited in claim 1, wherein the network of devices comprises one or more control devices.

12. The apparatus as recited in claim 1, wherein said broker is disposed within a second one or more of the devices in the network, and wherein said first and second one or more of the devices may comprise common ones of the devices.

13. A management mechanism, for controlling the power or bandwidth consumed by devices within a network, said management mechanism comprising:
a service broker, configured to monitor traffic over the network, and configured to direct a first one or more of the devices to operate in a tokenized data mode, said service broker comprising:
dynamic tokenization logic, configured to provide a tokenized definition, if required, to be transmitted along with a tokenized mode command to said first one or more of the devices; and
a token processor, disposed within said first one or more of the devices in the network, configured to receive first tokenized data from said service broker and to decode said first tokenized data into first meaningful data, and configured to encode second meaningful data into second tokenized data for transmission to said service broker.

14. The management mechanism as recited in claim 13, wherein the network of devices comprises a plurality of wireless devices communicating over a wireless network medium.

15. The management mechanism as recited in claim 13, wherein the network is configured according to ZIGBEE standards.

16. The management mechanism as recited in claim 13, wherein the network of devices comprises a combination of wired and wireless devices communicating over a wired network medium and wireless network medium, and wherein said service broker provides for interconnection of the network of devices.

17. The management mechanism as recited in claim 13, wherein said tokenized data comprises compressed data corresponding to a plurality of fields within a transport level packet.

18. The management mechanism as recited in claim 17, wherein said plurality of fields comprise a message ID field, a service ID field, and a property ID field.

19. The management mechanism as recited in claim 18, wherein said plurality of fields further comprise a data field.

20. The management mechanism as recited in claim 13, wherein said service broker is disposed within a second one or more of the devices in the network, and wherein said first and second one or more of the devices may comprise common ones of the devices.

21. A method of optimizing power or bandwidth consumed by a network of devices, the method comprising:
monitoring traffic over the network;
directing a first one or more of the devices in the network to operate in a tokenized data mode; and
within the first one or more of the devices in the network, receiving first tokenized data and decoding the first tokenized data into first meaningful data, and encoding second meaningful data into second tokenized data for transmission.

22. The method as recited in claim 21, wherein the network of devices comprises a plurality of wireless devices communicating over a wireless network medium.

23. The method as recited in claim 21, further comprising:
configuring the network of devices according to ZIGBEE standards.

24. The method as recited in claim 21, wherein the network of devices comprises a combination of wired and wireless devices communicating over a wired network medium and a wireless network medium, and wherein said service broker provides for interconnection of the network of the devices.

25. The method as recited in claim 21, wherein said directing comprises:
first transmitting a tokenized mode command to the first one or more of the devices to direct operation in the tokenized data mode.

26. The method as recited in claim 25, wherein said directing further comprises:
second transmitting a tokenized definition along with the tokenized mode command to the first one or more of the devices.

27. The method as recited in claim 21, wherein the tokenized data comprises compressed data corresponding to a plurality of fields within a transport level packet.
